(19) United States
(12) Patent Application Publication
(10) Pub. No.: US 2022/0095227 A1
(43) Pub. Date: Mar. 24, 2022

(54) METHODS AND APPARATUSES TO REDUCE DC/CA SETUP TIME

(71) Applicant: MEDIATEK INC., Hsinchu City (TW)

(72) Inventors: Chun-Fan TSAI, Hsinchu City (TW); Yuanyuan ZHANG, Beijing (CN)

(21) Appl. No.: 17/420,820

(22) PCT Filed: Jan. 21, 2020
(86) PCT No.: PCT/CN2020/073485

§ 371 Date: Jul. 6, 2021

Related U.S. Application Data
(60) Provisional application No. 62/799,781, filed on Feb. 1, 2019.

(51) Int. Cl. H04W 52/02; H04W 72/04; H04W 76/34

(52) U.S. Cl. CPC H04W 52/0229; H04W 24/10; H04W 76/34; H04W 72/0453

(57) ABSTRACT

Aspects of the disclosure provide methods and apparatus for radio resource control. For example, an apparatus includes transceiver circuitry and processing circuitry. The transceiver circuitry is configured to transmit and receive wireless signals. The processing circuitry is configured to control, when the apparatus is in a power saving mode, the transceiver circuitry to perform a measurement of a potential carrier provided by a network system for communication usage by the apparatus in a connected mode. Then, the processing circuitry provides, before a transition of the apparatus from the power saving mode to the connected mode and via the transceiver circuitry, a result of the measurement of the potential carrier, to the network system. Further, the processing circuitry receives, in the connected mode, carrier configuration information that is determined by the network system based on the result of the measurement of the potential carrier.

### INCORPORATION BY REFERENCE

This present disclosure claims the benefit of U.S. Provisional Application No. 62/799,781, “Methods and Apparatus to Reduce DC/CA Setup Time” filed on Feb. 1, 2019, which is incorporated herein by reference in its entirety.

### TECHNICAL FIELD

The disclosed embodiments relate generally to wireless network communications, and, more particularly, to carrier aggregation (CA) technology and dual connectivity (DC) design in 5G new radio wireless communications systems.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Various technologies are developed in mobile communication. For example, carrier aggregation (CA) technology and dual connectivity (DC) technology enable a user equipment (UE) to be assigned with multiple component carriers, thus the UE can use the multiple component carriers for data transmission, and throughput at the UE is the aggregated bandwidth of the multiple component carriers. In some examples of CA, the UE simultaneously transmits and receives data on the multiple component carriers from one base station. In some examples of DC, the UE simultaneously transmits and receives data on the multiple component carriers from two or more base stations.

### SUMMARY

Aspects of the disclosure provide methods and apparatus for radio resource control. For example, an apparatus includes transceiver circuitry and processing circuitry. The transceiver circuitry is configured to transmit and receive wireless signals. The processing circuitry is configured to control, when the apparatus is in a power saving mode, the transceiver circuitry to perform measurement of a potential carrier provided by a network system for communication usage by the apparatus in a connected mode. Then, the processing circuitry provides, before a transition of the apparatus from the power saving mode to the connected mode and via the transceiver circuitry, a result of the measurement of the potential carrier, to the network system. Further, the processing circuitry receives, in the connected mode, carrier configuration information that is determined by the network system based on the result of the measurement of the potential carrier.

In some embodiments, the processing circuitry receives, via the transceiver circuitry and when the apparatus is in the power saving mode, a message from the network system. The message includes an indicator indicative of a request for the result of the measurement of the potential carrier. Then, the processing circuitry transmits, via the transceiver circuitry, a response message including the result of the measurement of the potential carrier, in response to the request for the result of the measurement of the potential carrier.

In an embodiment, the processing circuitry transmits, via the transceiver circuitry and when the apparatus is in the power saving mode, an initiation message for the transition from the power saving mode to the connected mode. The initiation message includes an indicator that is indicative of an availability of the result of the measurement of the potential carrier.

In some examples, the processing circuitry is configured to switch on, the transceiver circuitry when the apparatus is in the power saving mode to perform the measurement of the potential carrier, and switch off, the transceiver circuitry after the measurement. In an example, the processing circuitry is configured to periodically switch on/off the transceiver circuitry when the apparatus is in the power saving mode to perform the measurement of the potential carrier.

In an embodiment, the processing circuitry receives information of the potential carrier in a release message that is sent from the network system to the apparatus before the apparatus enters the power saving mode. In another embodiment, the processing circuitry receives information of the potential carrier in system information that is broadcasted and received when the apparatus is in the power saving mode. In another embodiment, the processing circuitry determines at least one of a time duration for performing the measurement, a frequency for performing the measurement, a cell for performing the measurement according to a predefined measurement object.

In some embodiments, the processing circuitry reconfigures (adds) at least one of a primary secondary serving cell and/or a secondary serving cell based on the carrier configuration information.

Aspects of the disclosure also provide methods for radio resource management by a network system (e.g., a radio access network, a base station in radio access network, etc.). The method includes configuring, by a network system for providing carrier for communication usage, a user equipment (UE) to enter a power saving mode. Then, the method includes receiving, by the network system, a result of measurement of a potential carrier provided by the UE before a transition from the power saving mode to a connected mode. The measurement is performed by the UE in the power saving mode. Further, the method includes providing, by the network system, carrier configuration information that is determined based on the result of measurement of the potential carrier when the UE enters the connected mode. In some embodiments, the method also includes transmitting a message to the UE, and the message includes an indicator indicative of a request for the result of the measurement of the potential carrier.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a diagram of a wireless communication system according to some embodiments of the disclosure;

FIG. 2 shows a diagram of operations in a wireless communication system according to some embodiments of the disclosure; and

FIG. 3 shows a block diagram of a user equipment according to some embodiments of the disclosure.

### DETAILED DESCRIPTION OF EMBODIMENTS

Aspects of the disclosure provide techniques to reduce setup time for carrier aggregation (CA) and/or dual connectivity (DC). To configure or reconfigure CA/DC in a user equipment (UE), a network needs measurement report from the UE. Generally, a UE can perform measurements in a connected mode and sends a measurement report to the network upon request. In some examples, to save power, a UE can enter a power saving mode where user data is not exchanged with the network. To resume data transmission, the UE transits from the power saving mode to the connected mode. Performing measurements in the connected mode can take time and delay the setup for CA/DC at the time of mode transition from the power saving mode to the connected mode. Aspects of the disclosure provide techniques to provide early measurement report to the network before the UE resumes the connected mode, thus the network can configure the CA/DC for the UE when the UE resumes the connected mode with a reduced latency, and does not need to wait for the UE to perform measurements in the connected mode.

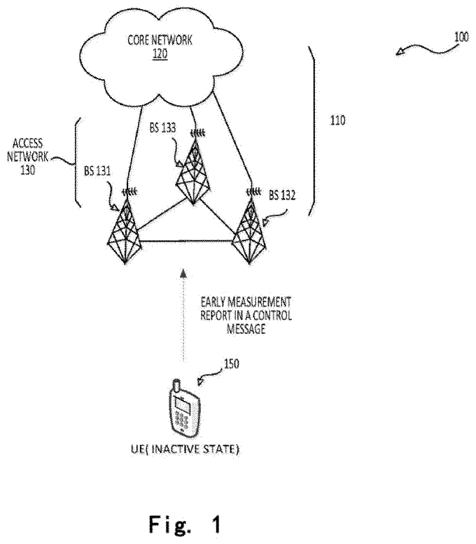

FIG. 1 shows a diagram of a wireless communication system 100 according to some embodiments of the disclosure. The wireless communication system 100 includes a network system 110 that provides communication services to various devices, such as a user equipment (UE) 150. The network system 110 and the UE 150 are suitably configured, thus the UE 150 can provide early measurement report (e.g., in a control channel) when the UE 150 is in a power saving mode, such as an inactive mode, an idle mode and the like where user data is not exchanged between the network system 110 and the UE 150.

In the FIG. 1 example, the wireless communication system 100 includes a network system 110 that includes a core network 120 and an access network 130 coupled together. The network system 110 can be any suitable network system. In an example, the network system 110 is a 5G system (5GS) that is configured based on the new radio (NR) technology. Then, the core network 120 can be a 5G core (5GC) network and the access network 130 can be a next generation (NG) radio access network (NG-RAN) for air interface. The NG-RAN may use either NR or evolved universal terrestrial radio access (E-UTRA) radio technology, or a mix of both at different network nodes. It is noted that the wireless communication system 100 can include other suitable component, such as an application server system (not shown).

In another example, the network system 110 is an evolved packet system (EPS) that is configured based on LTE technology. Then, the core network 120 can be an evolved packet core (EPC) network and the access network 130 can be an evolved universal terrestrial radio access network (E-UTRAN) 130 for air interface. The E-UTRAN may use E-UTRA radio technology.

In another example, the network system 110 is implemented using a mix of LTE technology and NR technology. For example, the network system 110 includes a first sub-system (not shown) based on LTE technology and a second sub-system (not shown) based on the NR technology. The two sub-systems are suitably coupled together.

The access network 130 includes one or more base stations that air-interface with user equipment using suitable technology and can provide control plane (e.g., for exchanges of control information) and user plane (e.g., for exchanges of user data) to user equipment. The base stations in the access network 130 are generally fixed stations that communicate with the user equipment and can also be referred to using other suitable terminology, such as evolved Node-B (eNB), a next generation Node-B (gNB), a base transceiver system, an access point and the like.

According to an aspect of the disclosure, carrier aggregation (CA) and/or dual connectivity (CA) are used in the wireless communication system 100. In a scenario, a base station, such as BS 131 allocates multiple component carriers, such as a first carrier with a center frequency f1 and a second carrier with a second frequency f2 that is different from f1, to the UE 150. The UE 150, which is capable of carrier aggregation, may transmit or receive data on the first carrier and the second carrier at the same time.

In another scenario, the UE 150 aggregates the first carrier with a center frequency f1 and the second carrier with a second frequency f2, while BS 131 transmits or receives a carrier with the center frequency f1 and BS 132 transmits or receives the carrier with the center frequency f2. Thus, the UE 150 can aggregate carriers transmitted or received from two or more base stations, which can be referred to as dual connectivity (DC).

In some examples, a cell can be used to refer a region that is served by a carrier, and can be used to refer the carrier that serves the region. The carrier can be characterized as a frequency band and a center frequency. When CA/DC is used, a UE, such as the UE 150 can be served by a number of serving cells, and one for each component carriers and can simultaneously transmits or receive data over a number of serving cells. The coverage of the serving cells can be different. In DC case, the cells are divided into two group, master cell group and secondary cell group. The primary cell in the mater cell group is referred to as Primary Cell (PCell) while the primary Cell of secondary cell group is referred to as Primary Secondary Cell (PSCell), and the other serving cells are referred to as secondary serving cells (SCell).

According to some aspects of the disclosure, the network system 110 configures or reconfigures CA/DC for the UE 150 based on measurement report provided from the UE 150. For example, the UE 150 performs reference signal received power (RSRP) measurement and/or reference signal received quality (RSRQ) measurement on certain frequencies, and includes measurement results in a measurement report. When the network system 110 receives the measurement report, the network system 110 can determine the primary serving cell and the secondary serving cell(s) according to suitable techniques.

Generally, the UE 150 performs the measurements in a connected mode. In some examples, in the connected mode, the UE 150 exchanges user plane data with the access network 130. The UE 150 performs measurements on a serving cell and neighboring cells and may pause data transmission and reception on the serving cell if needed. In the FIG. 1 example, the UE 150 is configured to be able to perform the measurements in the connected mode and in a power saving mode, such as an inactive state, and the like. According to some aspects of the disclosure, when there is no data exchange (e.g., no downlink traffic from the network system 110 to the UE 150 and no uplink traffic from the UE 150 to the network system 110) between the UE 150 and the network system 110 for certain time, the UE 150 can enter a power saving mode. In the power saving mode, the UE 150 does not exchange user plane data with the access network 130, and the UE 150 temporarily shuts down some circuitry, such as transceiver circuitry (e.g., a transmitter and a receiver) to save power.

In the power saving mode, the UE 150 periodically turns on the transceiver circuitry for various purpose. For example, the UE 150 periodically turns on the transceiver circuitry to monitor a paging signal. When the paging signal is indicative of pending downlink traffic to the UE 150, the UE 150 may resume back to the connected mode to receive the downlink traffic. When no downlink traffic is indicated by the paging signal, and the UE 150 has no uplink traffic, the UE 150 turns off the transceiver circuitry until a next paging interval in an example.

Further, in the FIG. 1 example, in the power saving mode, the UE 150 periodically (e.g., according to a measurement interval) turns on the transceiver circuitry to perform measurements on certain frequencies. In an example, the UE 150 can store the measurements and turn off the transceiver circuitry. The measurements can be provided in a measurement report at a later time.

It is noted that, in an example, when the measurement interval is set to be integer times of the paging interval, the UE 150 can perform measurements when the transceiver circuitry is turned on for the purpose of monitoring the paging signal.

Further according to some aspects of the disclosure, the UE 150 is configured to provide a measurement report to the network system 110 during a transition from the power saving mode to a connected mode. In some embodiments, the UE 150 is configured to provide the measurement report to the network system 100 during a transition from the power saving mode to the connected mode, and the measurement report can be included in one of the hand-shaking messages (or negotiation messages) from the UE 150 to the network system 110.

According to an aspect of the disclosure, the UE 150 transits from the connected mode to the power saving mode according to an RRC connection suspend procedure, and transits from the power saving mode to the connected mode according to an RRC connection resume procedure. During the RRC connection suspend procedure and the RRC connection resume procedure, some control messages are exchanged using control channels (control plane).

In some embodiments, the access network 130, such as the current primary serving cell, can start the RRC connection suspend procedure. In an example, the base station 131 is the primary serving cell and sends an RRC connection suspend message to the UE 150. This may happen, for example, after a certain period of time during which no data exchanges between the UE 150 and the access network 130 happen. The base station 131 and the UE 150 can negotiate, for example, power saving mode retention information (also referred to as RRC context), such as security related parameters (e.g., a security key), service parameters (e.g., a paging interval) and the like. In an example, the base station 131 sends an RRC connection release message to the UE 150, and the RRC connection release message includes a release cause that is set to “rrc-suspend”.

Both the UE 150 and the access network 130 (e.g., base station 131) stores the RRC context and an associated identifier (ID), which can be referred to as Resume ID. The RRC context includes, for example, bearer configuration and security related parameters. In some examples, the RRC connection release message includes the Resume ID and the security related parameters. In response to the RRC connection release message, the UE 150 stores the RRC context and the Resume ID and enters the power saving mode. In some examples, the core network 120 stores the RRC context.

In the power saving mode, the UE 150 turns off, for example, transceiver circuitry, when paging signal is unavailable and the UE 150 periodically turns on the transceiver circuitry at the paging interval, and monitors paging signal (carrying paging message) to check for pending downlink traffic. If a paging message indicates down link traffic or there is uplink traffic to transmit, the UE 150 performs RRC connection resume procedure.

In an example, to start the RRC connection resume procedure, the UE 150 can send a RRC connection resume request message to the access network 130. The RRC connection resume request message includes the previously received Resume ID, which the network system 110 can use to retrieve the RRC context. In an example, an authorization token is also provided to allow the access network 130 to securely identify the UE 150. Assuming that the RRC context is found and the authorization token is valid, the access network 130 responds with a RRC connection resume message to confirm that the connection is being resumed. The UE 150 then acknowledges the reception by sending a RRC connection resume complete message, and enters the connected mode.

According to an aspect of the disclosure, the UE 150 can include the measurement report in one of the control messages, such as the RRC connection resume complete message, and the like that is sent to the access network 130 during the RRC connection resume procedure. Thus, the access network 130 have the measurement report when the UE 150 enters the connected mode, and can configure or reconfigure CA/DC for the UE 150.

In some embodiments, the UE 150 includes the measurement report in one of the control messages in response to a measurement request from the access network 130. In an example, the access network 130 includes an indicator in the RRC connection resume message, and the indicator is indicative of the measurement request from the access network 130.

In some embodiments, the UE 150 can use one of the control messages to inform whether measurement report is available. In an example, the UE 150 is configured to include an indicator in the RRC connection resume request message. The indicator is indicative of whether a measurement report is available at the UE 150.

According to some aspects of the disclosure, the frequencies or cells to measure in the power saving mode can be informed to the UE 150 via various techniques. In an embodiment, the frequencies and the cells to measure are determined according to measurement objects. In some examples, the measurement objected are predefined. The access network 130 can provide a list of frequencies to measure or a blacklist of frequencies not to measure in the form of measurement objects.

In another example, the access network 130 can specify the frequencies or cells to measure in the RRC connection release message that is sent to the UE 150 during the transition from the connected mode to the power saving mode. In another example, the frequencies and the cells to measure is provided using system information that is broadcasted by a serving cell.

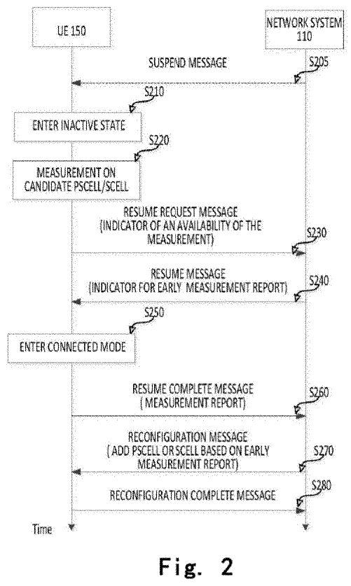

FIG. 2 shows a diagram of a process of operations in a wireless communication system, such as the wireless communication system 100, according to an embodiment of the disclosure. The process starts at S205.

At S205, a RRC suspend message is sent from the network system 110 to the UE 150. In some embodiments, the UE 150 is in the connected mode, and there is no user data exchange between the network system 110 and the UE 150. In an example, the base station 131 is the primary serving cell and after a certain period of no data exchange between the network system 110 and UE 150, the base station 131 sends an RRC connection suspend message to the UE 150. In some examples, the RRC connection suspend message can include RRC context for the UE 150. The RRC context for the UE 150 is also stored at a network component in either the access network 130 or the core network 120. The UE 150 then stores the RRC context.

The RRC context includes the RRC connection information, such as parameters relating to the current configuration of radio bearers, radio resources, temporary cell identifiers, security parameters or keys, MAC configuration, physical layer configuration, and measurement and reporting configuration. In an example, the RRC connection suspend message includes a resume ID associated with the RRC context that is stored in the network system 110.

In some examples, the RRC connection suspend message also includes, measurement information, such as measurement interval, frequencies or cells to measure, and the like. In an example, the RRC connection suspend message is sent as a type of RRC connection release message. For example, the base station 131 sends an RRC connection release message to the UE 150, and the RRC connection release message includes a release cause that is set to “rrc-suspend” or the RRC connection release message includes configuration for inactive mode in “suspendConfig”.

At S210, the UE 150 enters a power saving mode, such as an inactive state. In the power saving mode, the UE 150 does not exchange user plane data with the access network 130, and the UE 150 temporarily shuts down transceiver circuitry (e.g., a transmitter and a receiver) to save power.

At S220, in the power saving mode (e.g., inactive state), the UE 150 periodically, according to the measurement interval, turns on the transceiver circuitry to perform measurements on certain frequencies, then the UE 150 can store the measurements and turn off the transceiver circuitry. In an embodiment, the frequencies and cells to measure are configured in measurement objects that can be pre-defined. In another embodiment, the frequencies and cells to measure are configured according to the RRC connection suspend message. In another embodiment, the frequencies and cells to measure are configured based on the system information of the current serving cell that is broadcasted and received by the UE 150.

In the power saving mode (e.g., inactive state), the UE 150 also periodically turns on the transceiver circuitry to monitor a paging signal. The paging signal can carry an indicator for pending downlink traffic for the UE 150. When the paging signal is indicative of pending downlink traffic to the UE 150, the UE 150 can resume back to the connected mode to receive the downlink traffic. When no downlink traffic is indicated by the paging signal, and the UE 150 has no uplink traffic, the UE 150 turns off the transceiver circuitry until a next paging interval in an example.

At S230, when the UE 150 receives a paging signal that is indicative of pending downlink traffic or the UE 150 has uplink traffic, the UE 150 can send a RRC connection resume request message to the network system 110. The RRC connection resume request message includes the previously received resume ID, which the network system 110 can use to retrieve the RRC context. In an example, an authorization token is also provided to allow the network system 110 to securely identify the UE 150. Further, in some embodiments, the RRC connection resume request message also includes an indicator that is indicative whether measurement results of frequencies or cells are available at the UE 150.

At S240, the network system 110 receives the RRC connection resume request message, and extracts information, such as the resume ID, authorization token, the indicator for an availability of measurement results from the RRC connection resume request message. Then, the network system 110 can retrieve the RRC context based on the resume ID and can authorize the UE 150 based on the authorization token. When the UE 150 is authorized based on the authorization token, the network system 110 reestablishes the connection based on the RRC context that is retrieved based on the resume ID. Then, the network system 110 sends a RRC connection resume message to confirm that the connection is being resumed. In an example, when the indicator indicates that the measurement results are available at the UE 150, the network system 110 includes an indicator in the RRC connection resume message, and the indicator is used to indicate whether the UE 150 should include measurement results in a RRC connection resume complete message.

At S250, in response to the RRC connection resume message, the UE 150 enters the connected mode. In an example, the UE 150 keeps the transceiver circuitry being turned on.

At S260, the UE 150 extracts, from the RRC connection resume message, the indicator associated with measurement. When the indicator in the RRC connection resume message indicates a request to include the measurement results, the UE 150 includes the measurement results in an RRC connection resume complete message and sends the RRC connection resume complete message to the network system 110.

At S270, the network system 110 receives the RRC connection resume complete message, and extracts the measurement results. Based on the measurement results, the network system 110 determines any updates on the CA/DC configuration for the UE 150, such as changes of primary secondary serving cell, changes of the secondary serving cells. Then, the network system 110 sends an RRC reconfiguration message that carries the updated CA/DC configuration information to the UE 150.

At S280, the UE 150 receives the RRC reconfiguration message, and updates CA/DC configuration information according to the RRC reconfiguration message. Then, the UE 150 transmits and receives user data according to the updated RRC configuration information. The UE 150 can send a RRC reconfiguration complete message to the network system 110 to inform the complete of the reconfiguration.

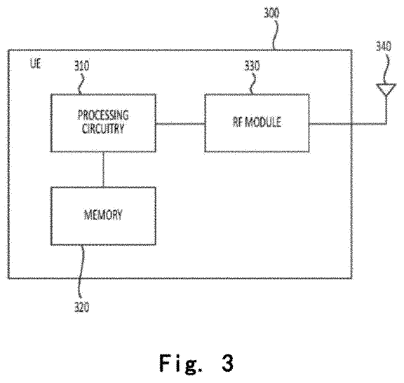

FIG. 3 shows a block diagram of a UE 300 according to embodiments of the disclosure. In an example, the UE 150 can be configured in the same manner as the UE 300. The UE 300 can be configured to perform various functions in accordance with one or more embodiments or examples described herein. Thus, the UE 300 can provide means for implementation of techniques, processes, functions, components, systems described herein. For example, the UE 300 can be used to implement functions of any of the UE 150 in various embodiments and examples described herein. The UE 300 can be a general purpose computer in some embodiments, and can be a device including specially designed circuits to implement various functions, components, or processes described herein in other embodiments. The UE 300 can include processing circuitry 310, a memory 320, a radio frequency (RF) module 330, and an antenna 340.

In various examples, the processing circuitry 310 can include circuitry configured to perform the functions and processes described herein in combination with software or without software. In various examples, the processing circuitry can be a digital signal processor (DSP), an application specific integrated circuit (ASIC), programmable logic devices (PLDs), field programmable gate arrays (FPGAs), digitally enhanced circuits, or comparable device or a combination thereof.

In some other examples, the processing circuitry 310 can be a central processing unit (CPU) configured to execute program instructions to perform various functions and processes described herein. Accordingly, the memory 320 can be configured to store program instructions. The processing circuitry 310, when executing the program instructions, can perform the functions and processes. The memory 320 can further store other programs or data, such as operating systems, application programs, and the like. The memory can include transitory or non-transitory storage medium. The memory 320 can include a read only memory (ROM), a random access memory (RAM), a flash memory, a solid state memory, a hard disk drive, an optical disk drive, and the like. The processing circuitry 310 can perform various functions, such as switching on/off power to the other circuitry, controlling RF module 330 to perform measurements on frequencies or cells, extracting indicator(s) from a message, including indicators, or measurement results in a message, and the like.

The RF module 330 receives processed data signal from the processing circuitry 310 and transmits the signal in a beam-formed wireless communication network via an antenna 340, or vice versa. The RF module 330 can includes transmitting circuit and receiving circuit (or transceiver circuitry) that can transmit signals carrying outgoing messages or receive signals that carry incoming messages. The RF module 330 can include a digital to analog convertor (DAC), an analog to digital converter (ADC), a frequency up converter, a frequency down converter, filters, and amplifiers for reception and transmission operations. The RF module 330 can include multi-antenna circuitry (e.g., analog signal phase/amplitude control units) for beamforming operations. The antenna 340 can include one or more antenna arrays. The RF module 330 can also include circuit that can perform measurements on frequencies or cells.

The UE 300 can optionally include other components, such as input and output devices, additional or signal processing circuitry, and the like. Accordingly, the UE 300 may be capable of performing other additional functions, such as executing application programs, and processing alternative communication protocols.

The processes and functions described herein can be implemented as a computer program which, when executed by one or more processors, can cause the one or more processors to perform the respective processes and functions. The computer program may be stored or distributed on a suitable medium, such as an optical storage medium or a solid-state medium supplied together with, or as part of, other hardware. The computer program may also be distributed in other forms, such as via the Internet or other wired or wireless telecommunication systems. For example, the computer program can be obtained and loaded into an apparatus, including obtaining the computer program through physical medium or distributed system, including, for example, from a server connected to the Internet.

The computer program may be accessible from a computer-readable medium providing program instructions for use by or in connection with a computer or any instruction execution system. The computer readable medium may include any apparatus that stores, communicates, propagates, or transports the computer program for use by or in connection with an instruction execution system, apparatus, or device. The computer-readable medium can be magnetic, optical, electronic, electromagnetic, infrared, or semiconductor system (or apparatus or device) or a propagation medium. The computer-readable medium may include a computer-readable non-transitory storage medium such as a semiconductor or solid state memory, magnetic tape, a removable computer diskette, a random access memory (RAM), a read-only memory (ROM), a magnetic disk and an optical disk, and the like. The computer-readable non-transitory storage medium can include all types of computer readable medium, including magnetic storage medium, optical storage medium, flash medium, and solid state storage medium.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

1. A method for radio resource management, comprising:
performing, by a UE in a power saving mode, a measurement of a potential carrier provided by a network system;
providing, during a transition of the UE from the power saving mode to the connected mode, a result of the measurement of the potential carrier, from the UE to the network system; and
receiving, by the UE in a connected mode, carrier configuration information that is determined by the network system based on the result of the measurement of the potential carrier.

2. The method of claim 1, further comprising:
receiving, by the UE in the power saving mode, a message from the network system, the message including an indicator indicative of a request for the result of the measurement of the potential carrier; and
transmitting a response message including the result of the measurement of the potential carrier, to the request for the result of the measurement of the potential carrier.

3. The method of claim 1, further comprising:
switching on, transceiver circuitry by the UE in the power saving mode to perform the measurement of the potential carrier; and
switching off, the transceiver circuitry by the UE in the power saving mode after the measurement.

4. The method of claim 3, further comprising:
periodically switching on/off the transceiver circuitry by the UE in the power saving mode to perform the measurement of the potential carrier.

5. The method of claim 1, further comprising:
receiving information of the potential carrier in a release message that is sent from the network system to the UE before the UE enters the power saving mode.

6. The method of claim 1, further comprising:
receiving information of the potential carrier as system information that is broadcasted and received when the UE is in the power saving mode.

7. The method of claim 1, further comprising:
reconfiguring at least one of a primary secondary serving cell and/or a secondary serving cell based on the carrier configuration information.

8. An apparatus, comprising:
transceiver circuitry configured to transmit and receive wireless signals; and
processing circuitry configured to:
control, when the apparatus is in a power saving mode, the transceiver circuitry to perform a measurement of a potential carrier provided by a network system;
provide, during a transition of the apparatus from the power saving mode to the connected mode and via the transceiver circuitry, a result of the measurement of the potential carrier, to the network system; and
receive, in a connected mode, carrier configuration information that is determined by the network system based on the result of the measurement of the potential carrier.

9. The apparatus of claim 8, wherein the processing circuitry is configured to:
receive, via the transceiver circuitry and when the apparatus is in the power saving mode, a message from the network system, the message including an indicator indicative of a request for the result of the measurement of the potential carrier; and
transmit, via the transceiver circuitry, a response message including the result of the measurement of the potential carrier, to the request for the result of the measurement of the potential carrier.

10. The apparatus of claim 8, wherein the processing circuitry is configured to:
switch on, the transceiver circuitry when the apparatus is in the power saving mode to perform the measurement of the potential carrier; and
switch off, the transceiver circuitry after the measurement.

11. The apparatus of claim 10, wherein the processing circuitry is configured to:
periodically switch on/off the transceiver circuitry when the apparatus is in the power saving mode to perform the measurement of the potential carrier.

12. The apparatus of claim 8, wherein the processing circuitry is configured to:
receive information of the potential carrier in a release message that is sent from the network system to the apparatus before the apparatus enters the power saving mode.

13. The apparatus of claim 8, wherein the processing circuitry is configured to:
receive information of the potential carrier as system information that is broadcasted and received when the apparatus is in the power saving mode.

14. The apparatus of claim 8, wherein the processing circuitry is configured to:
reconfigure at least one of a primary secondary serving cell and/or a secondary serving cell based on the carrier configuration information.

15. A method for radio resource management, comprising:
configuring, by a network system for providing carrier for communication usage, a user equipment (UE) to enter a power saving mode;
receiving, by the network system, a result of measurement of a potential carrier provided by the UE before a transition from the power saving mode to a connected mode, the measurement being performed by the UE in the power saving mode; and
providing, by the network system, carrier configuration information that is determined based on the result of measurement of the potential carrier when the UE enters the connected mode.

16. The method of claim 15, further comprising:
transmitting a message to the UE, the message including an indicator indicative of a request for the result of the measurement of the potential carrier.
